(19) United States
(12) Patent Application Publication
(10) Pub. No.: US 2021/0283941 A1
(43) Pub. Date: Sep. 16, 2021

(54) Polymer Laminate Comprising at Least One Diffraction Element and Method for Producing it

(71) Applicant: COVESTRO DEUTSCHLAND AG, LEVERKUSEN (DE)

(72) Inventors: ANDRE LEOPOLD, BERLIN (DE); OLGA KULIKOVSKA, BERLIN (DE); KATHRIN KLUENDER, BERLIN (DE); MANFRED PAESCHKE, WANDLITZ (DE); ENRICO ORSELLI, KOELN (DE); THOMAS ROELLE, LEVERKUSEN (DE); WIELAND HOVESTADT, LEICHLINGEN (DE); DENNIS HOENEL, ZUELPICH (DE)

(21) Appl. No.: 16/321,701

(22) PCT Filed: Jul. 21, 2017
(86) PCT No.: PCT/EP2017/068444

§ 371 Date: Jan. 29, 2019

(30) Foreign Application Priority Data
Jul. 29, 2016 (DE) 102016214070.1

(51) Int. Cl. B42D 25/455; B42D 25/328; B42D 25/46; G02B 5/18

(52) U.S. Cl. CPC B42D 25/455; B42D 25/328; B42D 25/23; G02B 5/1847; B42D 25/46

(57) ABSTRACT

A production method for a polymer laminate with at least one diffraction element is simplified. The method includes the following method steps: providing a diffraction element material with a carrier film and a light-sensitive layer located thereon, and also at least one polymer layer; producing the at least one diffraction element by creating a light-diffracting layer from the light-sensitive layer, in that a light-diffracting pattern is created in the light-sensitive layer of the at least one diffraction element material; bringing together the at least one diffraction element and at least one polymer layer to form a stack of layers; and surface bonding the at least one diffraction element and the at least one polymer layer 170 by way of a lamination process, thereby forming the polymer laminate.

### FIELD OF THE INVENTION

The present invention relates to a polymer laminate that is equipped with one or a plurality of diffraction elements, for example one or a plurality of volume holograms, and to a production method for polymer laminates with diffraction elements. Such polymer laminates are preferably used for the production of value or security products, for example value or security documents.

### PRIOR ART AND BACKGROUND OF THE INVENTION

Value or security products, in particular value or security documents, are used to verify the identity of a person, for example when crossing a national border, or the identity of a thing or a claim, for example for payment of a sum of money or delivery of a retail product or provision of a service. Among other features, the value or security products show visually recognizable features that clearly associate them with the person and/or thing and/or a cash or securities account and allow only the holder to identify him or herself or to have at his or her disposal the thing or account, and for example to initiate money transfers. For these reasons, the value or security products must be protected against fraud. In order to achieve this, it must be ensured that it is impossible or only possible with considerable effort to imitate, forge or falsify the value or security product. The value or security product therefore comprises security features that are extremely difficult or even practically impossible to imitate. For example, as in the case of bank notes, the product is composed of a material that is not readily available. Additionally or alternatively, security features can be formed by special inks, for example luminescent or optically variable inks, optical elements such as holograms, lenticular images, kinegraphic objects, lens or prism arrays, further guilloches, mottled fibers, security threads, etc. Moreover, it is also necessary for the value or security products to be simply producible.

For example, optical security features in the form of security elements can be separately produced, and then as patches, layers, security threads, security strips or the like, be adhesively bonded to an outer surface of a value or security document or to an inner surface of the value or security document. Such security elements can be optically variable elements, such that visually perceptible features, depending on the angle from which the value or security product is perceived, are either recognizable and/or can take on a different appearance.

For example, it can be seen from DE 102009007552 A1 that value or security documents can be provided for example with a security feature produced by holographic, in particular volume holographic methods. DE 102009007552A1 discloses a method for producing multilayer security products that are composed of at least one card and at least one polymer film applied to at least one side of the card from a laminate, wherein the polymer film is provided as rolled material and has at least one personalized security feature. The roller path of the polymer film can be individualized and for example comprise holograms.

A novel holographic recording material is described in “Holographic recording aspects of high-resolution Bayfol® HX photopolymer,” Proc. of SPIE, Vol. 7959 79570H-1 by H. Berneth, F.-K. Bruder, T. Fäcke, R. Hagen, D. Hönel, D. Jurbergs, T. Rolle, and M.-S. Weiser. This material is used for producing volume holograms and does not require chemical or thermal processing. The photopolymer is formed from a polymer network containing dissolved chemical compounds for registration of the holographic information. It is exposed to laser light in the spectral region of 440 nm to 660 nm. The photopolymer is used in a three-layer film as a substrate between a removable protective film of polyethylene and a polyethylene terephthalate film.

The numerous processing steps in the production of identification documents (ID documents) result in a complex flow of the production process. Essential steps in the production process are production of polymer layers provided with security features, bringing together of the polymer layers provided with security features and further polymer layers to form a stack, lamination of the stack into a laminate, production of a hologram and bonding of the hologram to the laminate. As the steps are carried out successively, production of a document requires a considerable period of time. Moreover, the steps are complex and thus prone to error. It has also been found that integration of the production of personalized holograms into the production process as a whole is unfavorable. This results in highly disadvantageous flow of the production process, which necessitates complex logistics because of the required precise assignment of the personalized substrates (laminates) and hologram elements to one another. Finally, complicated and thus costly and complex facilities are required for production.

### OBJECTS OF THE INVENTION

Therefore, an object of the present invention is to provide a production method for value or security products, in particular value or security documents having diffraction elements, in particular hologram elements, in which the above-mentioned drawbacks do not occur and which in particular is simpler and less complex than the known methods. Moreover, the aim is to provide a method with less stringent logistical requirements for implementation, so that it is possible to reliably assign individualized components of a value or security product. This is also intended to allow a problem-free process flow of the method, including the production of diffraction elements.

### Definition of the Terms Used According to the Present Invention

When terms are used in the singular below, such as ‘diffraction element,’ ‘polymer layer,’ ‘security feature’ etc., this can also be understood to refer to the corresponding plural forms thereof, namely ‘diffraction elements,’ ‘polymer layers,’ ‘security features’ etc., and vice versa, unless expressly stated otherwise.

When the term ‘value or security product,’ which in particular can be a value or security document or a security element, is used in the description and in the claims of the present application, this is to be understood as referring for example to a personal identification card, a driver's license, an access control identification card or another ID document, for example an identification card (ID card), a vehicle license, a check, bank, credit or cash card, customer card, health card, company identification card, proof of authorization, membership card, gift or shopping voucher or another value or security document. A value or security product according to the invention can also be a value or security element, for example a sticker, an adhesive label (for example for product security), a patch or the like that comprises a diffraction element according to the present invention and can be undetachably bonded to a precursor product of a value or security document (polymer laminate) or another article, for example a retail product to be labelled whose authenticity is to be guaranteed, in order to form the value or security document or this labelled article. For example, this article can be a copy of a limited series of identical objects, the exclusivity of which is to be documented by numbering. This numbering can be carried out by individualizing the value or security element provided with the diffraction element. In particular, the value or security product can be a smart card if the product is in card form. The value or security product can be in the format ID-1, ID-2, ID-3, ID-T or in any other standardized or non-standardized format, for example in card form. For this purpose, reference is made to the relevant standard ISO/IEC 7810 in the version valid on the priority date of this application. Preferably, the format of the value or security product is ID-1. The value or security product is to meet the standardized requirements, for example ISO 10373, ISO/IEC 7810, ISO 14443 and if applicable the standard ISO/DIS 18328-2, which is still in draft form, in the respective versions valid on the priority date of this application.

The value or security product can be composed of a polymer selected from the group comprising polycarbonate (PC), in particular bisphenol A polycarbonate, polyethylene terephthalate (PET), derivatives thereof such as glycol-modified PET (PETG), polyethylene naphthalate (PEN), polyvinylchloride (PVC), polyvinyl butyral (PVB), polymethyl methacrylate (PMMA), polyimide (PI), polyvinyl alcohol (PVA), polystyrene (PS), polyvinyl phenol (PVP), poly-propylene (PP), polyethylene (PE), thermoplastic elastomers (TPEs), in particular thermoplastic polyurethane (TPU), acrylonitrile-butadiene-styrene copolymer (ABS) and derivatives thereof, or paper, cardboard, glass, metal or ceramics. Moreover, the product can also be produced from a plurality of these materials. Preferably, it is composed of PC or PC/TPU/PC. The polymers can be in either filled or unfilled form. In the latter case, they are preferably transparent or translucent. If the polymers are filled, they are opaque. Preferably, the product is produced from 3 to 12 films, preferably 4 to 10 films. The films can carry further printed layers.

When the terms ‘individualizing,’ ‘individualized,’ ‘personalizing’ and ‘personalized’ are used in the description and in the claims of the present application, this is to be understood as meaning that the value or security product to which the term refers is different from other value or security products and that this value or security product is to be associated with an entity (in the case of the terms ‘individualizing’ or ‘individualized’), in particular a person (in the case of the terms ‘personalizing’ or ‘personalized’). Instead of a person, the value or security product can be associated with a thing, such as a motor vehicle, a retail product (in this case, the value or security product is e.g. a sticker, label, tag or decal) or a security. The individualizing or personalizing allows a third party to recognize the clear association of the value or security product with the entity or groups of identical or similar entities.

### Basic Features of the Invention and Preferred Embodiments:

According to the concept on which the invention is based, instead of using the conventional method of bonding a finished hologram element or another diffraction element to a blank for a value or security product, in particular for a value or security document, a production method is used in which the diffraction element is subjected to the lamination process together with the other components of the polymer laminate, i.e. the diffraction element, as well as the other layers of the laminate, is used as a layer in lamination and bonded to the other layers in this manner. A separate bonding step can therefore be dispensed with.

The above-mentioned objects are thus achieved according to a first aspect of the present invention by means of a method for producing a polymer laminate comprising at least one diffraction element. The method comprises at least the following method steps:
(a) providing a diffraction element material and at least one polymer layer, wherein the diffraction element material comprises a carrier film and a light-sensitive layer located thereon;
(b) producing the at least one diffraction element by creating a light-diffracting layer from the light-sensitive layer, in that a light-diffracting pattern is created in the light-sensitive layer of the at least one diffraction element material;
(c) bringing together the at least one diffraction element and the at least one polymer layer to form a stack of layers; and
(d) surface bonding the at least one diffraction element and the at least one polymer layer by means of a lamination process, thereby forming the polymer laminate.

According to a second aspect of the present invention, a polymer laminate with at least one diffraction element is also provided, wherein the polymer laminate comprises no additional adhesive material for bonding the at least one diffraction element to the polymer layers of the polymer laminate. The reason is that the diffraction element is bonded by lamination to the other polymer layers of the polymer laminate.

According to a third aspect of the present invention, the polymer laminate is used for the (further) production of a value or security product, in particular a value or security document, in that it is used as a precursor product for the value or security product. For example, the polymer laminate can already largely have the security features of the value or security product, but not yet have all of the personalizing data, for example on its surface, and not yet be finally processed, for example by means of a finishing coating and/or edge processing and/or binding it into a booklet-type security document such as a passport. The present invention therefore also relates to a value or security product that has at least one diffraction element that does not require additional adhesive material for bonding the at least one diffraction element to polymer layers of a polymer laminate.

Binding of the diffraction element by means of a lamination process allows a solid bond to be achieved between the diffraction element and the further layers of the polymer laminate. This makes the previously-used adhesion process superfluous. This is advantageous in that a separate apparatus for application and subsequent adhesive bonding of the diffraction element to a document blank is no longer required, thus eliminating high investment, maintenance and operating costs. A further substantial advantage of the method according to the invention is also that the method is shorter than conventional methods because the separate application and adhesive bonding step can be dispensed with. The reason is that bonding of the diffraction element to the further polymer layers is carried out in a single method step, namely the lamination step. Moreover, the adhesive bond may constitute a weak point at which the document can be separated into several parts. The method according to the invention thus provides a value or security document that is more secure against forging and falsification than conventional documents.

By means of the method, a more favorable process flow in production of the polymer laminates is also achieved, because any already-individualized polymer layers can be simply and securely brought together with another individualized diffraction element and then bonded to one another in the lamination step. For example, this approach makes it possible to carry out production of the diffraction element simultaneously with the production of security features on one or a plurality of additional polymer layers, e.g. personalizing printing on one of the polymer layers such as a passport picture. As each of the two elements, the diffraction element and these other security features, can be individualized, it is possible to produce such elements in pairs with the same individualization and then bring them together. This allows a favorable production flow and more reliable assignment of the individual components of a polymer laminate to one another than with conventional methods.

Moreover, the present diffraction element material also differs in its structure from conventional materials for producing diffraction elements: the material usable in the production method according to the present invention has a carrier film on one side that has the function of being laminated as a component into the polymer laminate in the lamination process. For this reason, this film is not removed from the light-sensitive layer before bonding to the polymer layers. In the case of conventional materials, in contrast, protective films must be peeled from both sides of the light-sensitive layer. This requires an additional work step.

The diffraction element is preferably an element with a volume hologram, but can also be an element having a different diffraction pattern, for example a re-flection hologram, a Kinegram® or another diffractive structure, for example blazed structures, a linear grid, asymmetrical or symmetrical grid structures or zero-order diffraction structures, a cross grid or hexagonal grid or the like.

The diffraction element material contains a light-sensitive layer. Such layers are generally known and in common use for the application indicated. This is a layer composed of or comprising a photopolymer. In order to produce the diffraction element from the diffraction element material, the light-sensitive layer of this element is exposed in the usual manner, and the resulting light-diffracting pattern is then fixed in the layer (for example by means of UV radiation). The light-sensitive layer is preferably bonded to the carrier film via a thermally reactive adhesive. The diffraction elements are produced either in roll form or sheet form, and in the latter case, in individual or multiple blanks. Production in roll form followed by separation into individual blanks, which are then combined with the further layers in method step (c), is advantageous.

In a preferred embodiment of the present invention, the carrier film of the diffraction element is formed with PC or is composed of PC. As a rule, however, all materials from which a value or security product can be produced are suitable as the material of the carrier film. In particular, however, it is preferable if the carrier film is composed entirely of PC. On the other hand, if the carrier film is not completely composed of PC, the film material can be a polymer blend with further polymers, for example ABS. This film can have a thickness of preferably at least 15 μm, more preferably at least 25 μm and most preferably at least 40 μm. The carrier film can further have a thickness of not more than 300 μm, preferably not more than 200 μm and most preferably not more than 80 μm. The material of the carrier film can be transparent or translucent, i.e. sheer, without being transparent, or may be opaque. Moreover, the carrier film can be colorless, i.e. non-absorbent in the visible spectral region (400 nm to 750 nm), or colored, i.e. absorbent in the visible spectral region. If the carrier film is opaque, the carrier film material can be filled with a pigment. If the material contains a dye, it can have a transparent or translucent appearance, but also a colored appearance.

In a further preferred embodiment of the present invention, the diffraction element material can additionally have a scratch-resistant layer that is arranged on the side of the light-sensitive layer opposite the carrier film. The scratch-resistant layer can be formed from a mechanically resistant polymer such as PET or from another material commonly used for the production of value or security documents. The scratch-resistant layer can preferably have a thickness of at least 1 μm, more preferably at least 2 μm and most preferably at least 3 μm. The thickness can preferably be not more than 20 μm, further preferably not more than 12 μm and most preferably not more than 7 μm. The material of the scratch-resistant layer is preferably transparent or translucent, i.e. sheer, without being transparent. Moreover, the scratch-resistant layer can either be colorless, i.e. non-absorbent in the visible spectral region (400 nm to 750 nm), or colored, i.e. absorbent in the visible spectral region. If the material of the scratch-resistant layer contains a dye, it can have a transparent or translucent appearance, but also a colored appearance.

In yet a further preferred embodiment of the present invention, in the method steps (c) and (d), the scratch-resistant layer remains as a component of the polymer laminate to be produced on the light-diffracting layer. Accordingly, the scratch-resistant layer in this embodiment is not removed, for example peeled, from the diffraction element prior to method step (c).

The scratch-resistant layer imparts to the diffraction element the required properties of use, i.e. protection of the light-diffracting layer, for example against mechanical damage, and protection against adverse chemical effects, for example of chemicals such as solvents and swelling agents. This protection is more effective than the protection provided by conventional protective coatings if the scratch-resistant layer for example is composed of or comprises PET. This is particularly advantageous in cases where no further polymer layer such as a polymer film or a polymer coating layer, which would otherwise provide this protection, is arranged over the light-diffracting layer.

The diffraction element can take up the entire surface of the polymer laminate, preferably also the entire surface of the value or security product, in particular the value or security document, or only a portion thereof. For example, the diffraction element can comprise a hologram that takes up only a portion of the surface of the laminate or the value or security product or the value or security document. If the hologram shows a facial photograph of the document holder, the diffraction element can be smaller than the surface of the polymer laminate and also smaller than the surface of the value or security product or the value or security document. In an alternative embodiment, the diffraction element can form a security thread or an element having a format other than that of a thread and thus only take up a (small) fraction of the surface of the value or security product or the value or security document.

In a preferred embodiment of the present invention, at least one of the polymer layers that form the stack of layers together with the diffraction element can be formed with PC or composed of PC. As a rule, however, all materials from which a value or security product can be produced are suitable as the material of the polymer layers. In particular, however, it is preferable if these polymer layers are composed entirely of PC. On the other hand, if the polymer layers are not completely composed of PC, they can be composed for example of a blend with further polymers, for example ABS. The polymer layers can have any desired thickness within the limits imposed by the value or security product to be produced. Preferably, however, the thickness is at least 25 μm, further preferably at least 40 μm and most preferably at least 50 μm. The polymer layers can further have a respective thickness of not more than 300 μm, preferably not more than 200 μm and most preferably not more than 100 μm. The material of the polymer layers can be transparent or translucent, i.e. sheer, without being transparent, or may be opaque. Moreover, the polymer layers can be colorless, i.e. non-absorbent in the visible spectral region (400 nm to 750 nm), or colored, i.e. absorbent in the visible spectral region. If the polymer layers are opaque, the polymer layer material can be filled with a pigment. If the material contains a dye, it can have a transparent or translucent appearance, but also a colored appearance.

In yet a further preferred embodiment of the present invention, method step (c) comprises arranging the at least one diffraction element on an outer side of the stack of layers. This ensures that the optical effect imparted by the light-diffracting layer is clearly visible.

In yet a further preferred embodiment of the present invention, method step (c) comprises in a first alternative embodiment arranging the light-diffracting layer on the side of the carrier film of the at least one diffraction element in the stack of layers that is opposite the at least one polymer layer. The light-diffracting layer is thus located on the outer side of the polymer laminate, provided that no further components, such as the scratch-resistant layer, have been or are applied to the outer side. This also results in favorable visibility of the optical effect imparted by the light-diffracting layer. Moreover, the carrier film imparts the adhesive strength of the diffraction element to the other polymer layers.

In a second alternative embodiment, method step (c) comprises arranging the carrier film on the side of the light-diffracting layer of the at least one diffraction element in the stack of layers that is opposite the at least one polymer layer, so that the light-diffracting layer lies under the carrier film seen from the outside. In this alternative embodiment, the carrier film can be configured in the form of an embossing film, so that the following method step is carried out after method step (d): (e) embossing of microoptical elements in the material of the embossing film. The carrier film is thus arranged in method step (c) on an outer side of the stack of layers. The microoptical elements can be arranged in a matrix. For example, the microoptical elements can be microlenses or microprisms that are arranged in matrices (arrays). Such arrangements are known from the prior art (cf. for example EP 1953002 A2).

The embossing process can be carried out in lamination according to method step (d) with embossing plates that are used as pressing plates. For this purpose, the embossing plates have depressions and/or projections at the location that corresponds to the intended location for producing the microoptical elements. For example, depressions can be in the form of microlenses or microprisms, or else other microoptical elements, but in the form of the corresponding negative structures of these elements. During lamination, the structure of the microoptical elements is then formed in the surface of the material of the embossing film.

Alternatively, method step (c) can comprise additionally arranging a separate embossing film on the side of the stack of layers on which the at least one diffraction element is located. This embodiment is particularly preferred in cases where there is no protective film of the diffraction element material on the outer side of the stack of layers and where the light-diffracting layer according to the first alternative embodiment is located on the side of the carrier film in the stack of layers that is opposite the polymer layers. In this case as well, the following method step is carried out after method step (d): (e) embossing of microoptical elements in the material of the embossing film. The microoptical elements can be arranged in matrices.

A separate embossing film that is not formed by the carrier film can be composed of one of the materials from which the polymer layers are also formed. For this reason, all materials from which a value or security product can be produced are suitable. The embossing film is preferably formed with PC, i.e. it consists of PC or comprises PC and one or a plurality of further materials. The embossing film can preferably have a thickness of at least 15 μm, more preferably at least 25 μm and most preferably at least 40 μm. Furthermore, the thickness of the embossing film can preferably be not more than 300 μm, further preferably not more than 200 μm and most preferably not more than 80 μm. The material of the embossing film can be transparent or translucent, i.e. sheer, without being transparent. Moreover, the embossing film can either be colorless, i.e. non-absorbent in the visible spectral region (400 nm to 750 nm), or colored, i.e. absorbent in the visible spectral region. If the material of the embossing film contains a dye, it can have a transparent or translucent appearance, but also a colored appearance.

In yet a further preferred embodiment of the present invention, the diffraction element material comprises a protective film that is arranged in the diffraction element material on the side of the light-sensitive layer opposite the carrier film. The protective film preferably lies, directly or optionally over the scratch-resistant layer, against the light-sensitive or light-diffracting layer or optionally the scratch-resistant layer. This film serves to protect the light-sensitive layer, and after it is produced, the light-diffracting layer, against mechanical damage, contaminants such as dust, and the effects of chemicals such as solvents or swelling agents. This protection is more effective than that provided by conventional protective coatings. The protective film can be formed by an easily-peelable material, for example a silicone polymer or PE. It can preferably have a thickness of at least 8 μm, more preferably at least 12 μm and most preferably at least 15 μm. The protective film can further have a thickness of not more than 100 μm, preferably not more than 50 μm and most preferably not more than 30 μm. The protective film protects the document against adverse mechanical effects and the effects of chemicals such as solvents and swelling agents.

If the diffraction element material has both a scratch-resistant layer and a protective film, the structure of said diffraction element material in a first alternative embodiment is as follows: carrier film, light-sensitive layer applied thereto, scratch-resistant layer applied thereto, and protective film applied thereto. In the absence of one of the aforementioned components, i.e. the protective film or the scratch-resistant layer, the structure is to be adapted accordingly.

According to a first method variant of the latter embodiment of the present invention (having a protective film and optionally a scratch-resistant layer), the following method step is carried out after method step (b): (b1) peeling of the protective film from the light-sensitive or light-diffracting layer. The protective film is preferably peeled from the light-diffracting layer, and optionally from the scratch-resistant layer lying against the light-diffracting layer, immediately prior to the bringing together according to method step (c) so that adverse effects on the light-sensitive or light-diffracting layer are prevented. If the diffraction element material is present for example in roll form, the protective film can be grasped by an end section and gradually peeled from the material of the carrier film and the light-diffracting layer arranged thereon. In this case, after peeling of the protective film, pieces are cut from the rolled material that are then supplied to the laminating process. Alternatively, the diffraction element material can also be present in the form of a sheet-like product in a format that is suitable for the laminating process and can be further processed into sheet-like diffraction elements. In this case, the protective film sections on these product pieces are to be separately peeled. The protective film in this case is preferably a protective film that is easily peelable from the remainder of the diffraction element material, composed for example of a silicone polymer.

In a second alternative embodiment, the diffraction element material can have the following structure: protective film, light-sensitive layer applied thereto and scratch-resistant layer applied thereto. In this case, one can at least dispense with the scratch-resistant layer, although this layer is advantageous for the light-sensitive layer because of its protective effect. In this alternative embodiment, it is also suitable to use the protective film as an embossing film if the diffraction element material having the protective film facing the outer side of the stack of layers is brought together in method step (c) with the polymer layers.

In yet a further preferred embodiment of the present invention, at least one of the polymer layers is equipped with an electronic circuit. The electronic circuit can for example comprise a circuit for communication with a reading device, and for this purpose, in the usual manner, can either comprise an RFID circuit with an RFID chip and an RFID antenna for contactless communication with the reading device or be equipped with a chip module with external electrical contact surfaces for communication via electrical contacts. Alternatively or additionally, the electronic circuit can also be equipped with a display device such as an LED or OLED display and/or an input device such as a sensor and/or keyboard, and for this purpose can also comprise an electronic control and processing unit for these components. One of the polymer layers can be a compensation layer that has recesses or openings at the sites where a chip is located on the polymer layer with the electronic circuit and can be arranged on the side of this layer on which the chips are arranged.

Method step (c) of bringing together the diffraction element with the polymer layers is preferably carried out in an apparatus in which the individual laminate components can be successively placed atop one another. For this purpose, this apparatus comprises for example a collecting point on which the components can be placed atop one another to form the stack of layers. Conventional handling robots can be used to feed the laminate components, for example manipulation robots such as an SCARA (selective compliance assembly robot arm) robot, or a fast picker or portal crane.

After the layers are brought together to form the stack of layers according to method step (c), this stack is further processed in method step (d) into the polymer laminate. In particular, method step (d) comprises lamination of the individual layers (diffraction element and polymer layers) that is characterized by surface bonding under the action of heat and pressure, so that the layers soften at least superficially and thus bond together. In the case of layers composed of the same materials, adhesive bonds are thus formed in which the layers bonded to one another are no longer separable in a cross section because they are fused together, provided that the adjacent layers have highly similar refractive indices and materials are not enclosed on the surface that allow localization of the interface. A monolithic bond is formed in this manner. Accordingly, it is preferable in method step (d) to bond the at least one diffraction element and the at least one polymer layer to one another without using an additional adhesive material. This allows a particularly strong bond to be achieved between the individual layers that cannot be broken without completely destroying the layer structure of the laminate, unless a third material, namely an adhesive material, is arranged between said layers.

The laminating process is preferably a hot/cold laminating process, i.e. the stack of layers is first heated under planar pressing so that the layer materials soften and bond to one another, and then cooled while maintaining the pressing force so that solid bonding of the layers to one another is achieved. In this manner, one can dispense with separate materials that are placed between the layers to be bonded as additional layers and have the sole purpose of bonding the layers to one another (adhesive materials).

The laminating process is carried out in a laminating device that is configured either to receive multiple stacks of layers one on top of the other (discontinuous system) or in the form of a continuously operating system. In the former case, each stack of layers is each enclosed externally by one pressing plate and one press pad (lamination pressing tools). Pressure is applied externally to the stacks of layers and pressing plates by means of heatable press rams. The stacks of layers are heated by means of the press rams. The temperature in the hot phase of lamination can be in the range of 170-200° C., and preferably 180-190° C. During the lamination process, the stacks of layers between the lamination pressing tools are subjected to a pressure perpendicular to the surfaces of the lamination product stack. To the extent possible, this pressure should be so great that any air present between the layers during lamination is pressed out of the stacks of layers. In a first lamination phase (hot phase), the pressure can preferably be in a range of 100 to 120 N/cm², and in a second lamination phase (cold phase), it can preferably be in a range of 400 to 500 N/cm². In the case of continuous systems, the stacks of layers are successively transported along a feed path through the system, with pressure being exerted on the stacks of layers in each case. After the hot phase, in which the stacks of layers are subjected to the above-mentioned temperature and the above-mentioned pressure, they are subjected to the cold phase, in which the pressure is increased and the temperature is reduced to room temperature. In the case of the discontinuous system, these two phases are executed sequentially in the form of a processing program. In the case of the continuous system, the system comprises two processing lines in which the stacks of layers are subjected to the hot phase and the cold phase.

In yet a further preferred embodiment of the present invention, at least one of the polymer layers is provided with data. Such data can be individualizing, in particular personalizing, or else non-individualizing. In the case of personalizing data, these can be personal data on the document holder, for example a passport photo, the name, address, birth date, or birthplace of the holder. These data are preferably produced in the form of a print image reproduction in alphanumeric format on the polymer layer, for example by means of a digital printing process, in particular an inkjet printing process. For this purpose, the print image reproduction is printed on the polymer by means of the printing process. The print image reproduction is preferably produced on a surface of one of the polymer layers that is located inside the polymer laminate after lamination according to method step (d). This makes forging or falsification of the data considerably more difficult.

In yet a further preferred embodiment of the present invention, the data are produced on the at least one of the polymer layers simultaneously with the production of the at least one diffraction element from the diffraction element material. In this manner, during production of the diffraction element according to this preferred embodiment, the data-containing security feature is simultaneously produced on one of the polymer layers. The diffraction element and the polymer layer provided with the data can be produced virtually simultaneously, so that the production flow of the polymer laminate is further optimized.

The value or security product can comprise, in addition to the above-mentioned security features (diffraction element, data on the polymer layers, microoptical elements), at least one further security feature that is either individualizing or non-individualizing. Examples of further security features are guilloches, watermarks, embossing, security threads, microprinting, optically variable pigments, luminescent inks, see-through registers and the like.

The following figures serve to explain the invention in greater detail, and they are to be understood solely as illustrative examples that do not limit the scope of the invention.

FIG. 1 shows an ID card in an isometric view;

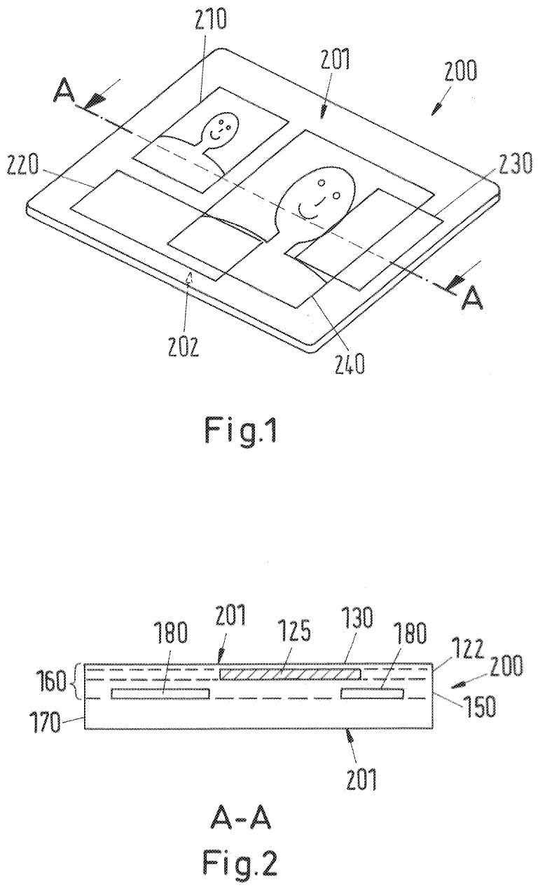

FIG. 2 shows a sectional view of the ID card of FIG. 1 along section line A-A;

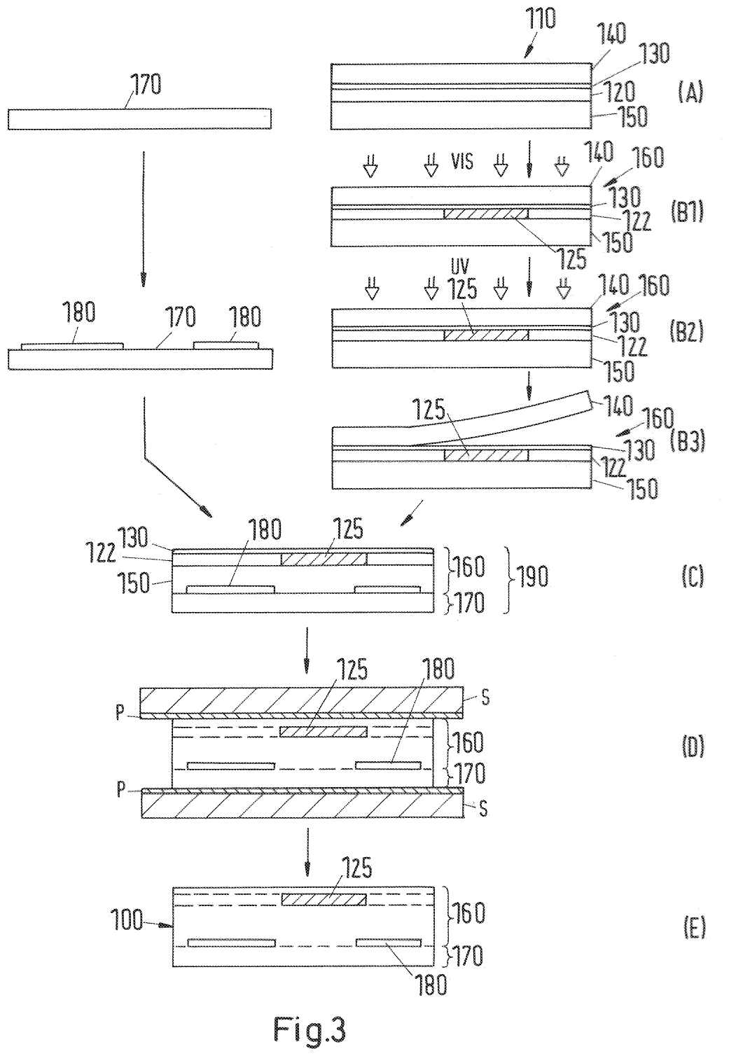

FIG. 3 shows successive method steps for the production of a polymer laminate for producing the ID card of FIG. 1 according to a first embodiment of the present invention in sectional views along section line A-A;

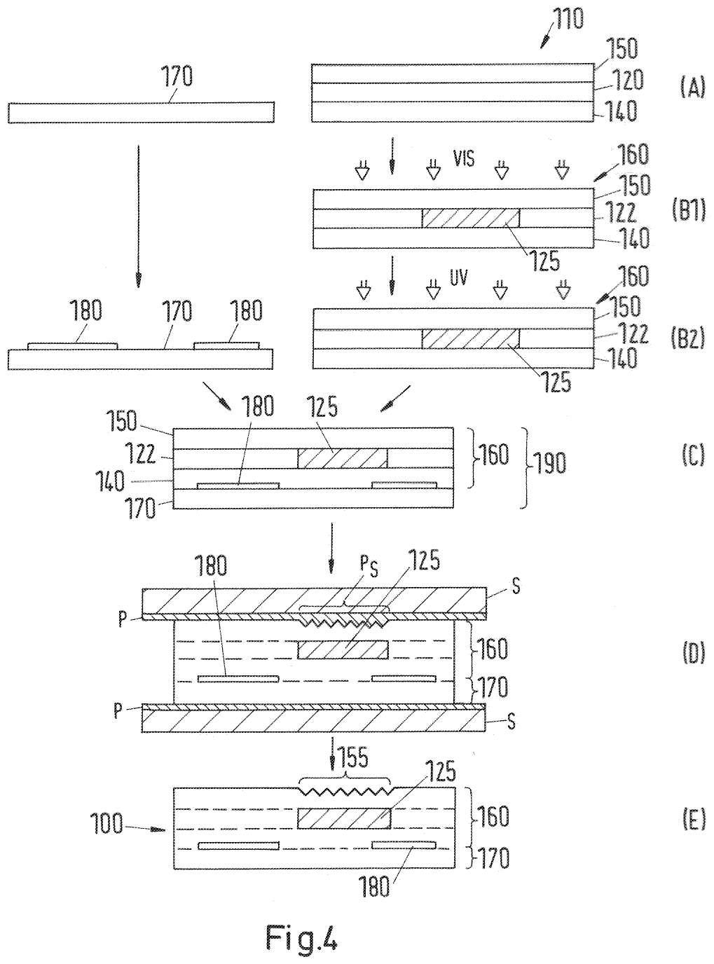

FIG. 4 shows successive method steps in the production of a polymer laminate for producing an ID card according to a second embodiment of the present invention in sectional views.

The same reference numbers in the figures indicate the same elements or elements having the same function. The drawing elements shown in the figures are not shown to scale or in natural proportions to one another.

The ID card 200 shown in FIG. 1 is a value or security document. For example, the card has the format ID 1. It has an upper side 201 and an underside 202 (not shown). Provided on the upper side of the card are a first field 210 and a fourth field 240 for a passport photo of the card holder and a second field 220 and a third field 230 for data of the card holder, for example reproduction of the name, birth date and birthplace, the address in plain text and an identification number of the ID card. These data and passport photos thus constitute individualizing, here personalizing, security features. While the passport photo in the first field and the data indicated in alphanumeric form in the second field and the third field are produced in a printing process, for example inkjet printing, the passport photo in the fourth field is formed by a volume hologram.

The ID card 200 of FIG. 1 is shown in a sectional view along section line A-A in FIG. 2. The ID card contains a polymer layer 170 of PC that is preferably opaque. Printed layers 180 are applied to the polymer layer that reproduce the print images in the first field 210 and in the third field 230. On the polymer layer is a diffraction element 160 in the form of a volume hologram that comprises various components, namely a light-diffracting layer 122, a carrier film 150 of PC and a scratch-resistant layer 130 of PET, wherein these layers have been fused to one another by the preceding laminating process so that the layers can no longer readily be separately recognized. The diffraction element has the same format as the PC layer and therefore covers it completely. In the light-diffracting layer, a light-diffracting pattern 125 is imprinted in the form of a volume hologram in only a limited area. The layers of the diffraction element are preferably transparent or at least translucent so that the print images and the volume hologram are visible from the upper side 201 of the ID card 200. The individual layers and sheets are indicated in the figure by dashed lines. However, these borderlines are only partially visible in a section, specifically only if two different materials having sufficiently differing refractive indices are adjacent to each other. In any event, this is not the case for the polymer layer and the carrier layer. Nevertheless, the printed layers are clearly recognizable because of their absorption in the visible spectral region.

For producing the ID card 200 according to FIG. 1, 2, a method is used according to the invention in which production of the volume hologram 125 and production of the print images 180 on the polymer layer 170 take place simultaneously. From the polymer laminate 100 produced according to the method, the ID card can be obtained in the form of an individual blank, for example by punching. Optionally, the ID card also comprises further security features to be added subsequently to the polymer laminate in order to produce the ID card.

The method for producing the polymer laminate 100 according to a first embodiment of the present invention is shown in FIG. 3.

In a first method step corresponding to method step (a) according to the invention, a diffraction element material 110, here a volume hologram element material, and a polymer layer 170, here a PC layer, are first provided (FIG. 3A). The volume hologram element material is composed of a series of layers (from bottom to top) of a carrier film 150 of PC, a light-sensitive layer 120 of a photopolymer applied thereto, a scratch-resistant layer 130 of PET applied thereto and a protective film 140 of PE that is applied thereto and closes off the series of layers in the drawing in a upward direction. The volume hologram element material can be in a roll format, so that a plurality of volume hologram elements 160 can be produced in the roll. Alternatively, the material can be used in the form of sheet-like pieces, which respectively correspond to individual blanks, for example.

The volume hologram element material 110 is exposed in a second method step (corresponding to method step (b) according to the claims) to the volume hologram pattern, wherein laser radiation in the visible spectral region VIS (for example in the range of 440 nm to 660 nm) is used (FIG. 3B1). The diffraction pattern produced in the photopolymer is limited to an area in the light-sensitive layer 120 that corresponds to the fourth field 240 on the ID card 200. This gives rise to a light-diffracting layer 122 containing a volume hologram 125. After this, the exposed light-sensitive layer is fixed, wherein the diffraction pattern produced in the material is exposed to UV radiation UV (FIG. 3B2). The result is that the pattern in the material is no longer modifiable. This gives rise to a volume hologram element 160 that comprises the carrier layer 150, the light-diffracting layer 122, the scratch-resistant layer 130 and the protective film 140.

In parallel to this, the print images 180 are produced on the PC layer 170. For this purpose, the passport picture and the alphanumeric data reproductions are produced in the first field 210, the second field 220 and the third field 230 by means of a printing process. A digital printing process can be used, for example an inkjet printing process. Alternatively, of course, other printing processes such as an offset process are also conceivable.

After recording of these individualizing data on the PC layer 170 and production of the volume hologram element 160, the protective film 140 on the upper side of the volume hologram element is peeled off (FIG. 3B3).

After this, the volume hologram element 160, the PC layer 170 and optionally further polymer layers (the latter not shown) are combined into a stack, wherein the PC layer lies against the carrier film 150 of the volume hologram element (FIG. 3C). A stack of layers 190 is produced. If the volume hologram element is a component of a multiple blank, for example in the form of a rolled material, the required individual blanks are cut from the multiple blank. This stack can then be fixed, for example clamped, for simplified handling so that the layers do not slide relative to one another.

After this, the stack of layers 190 is arranged between two pressing plates P and fed together with the pressing plates into a laminating press (FIG. 3D). There, it is placed between two heatable press rams S. The press rams are configured to heat the stack to an elevated temperature, for example 180° C., and also to exert pressure on the stack, for example 110 N/cm². Because of the pressure applied and the elevated temperature, the materials fuse with one another. This causes them to be firmly bonded to one another. The interfaces between the material layers partially disappear. A monolithic bond is produced between the layers. After the hot phase of lamination, a cold phase is carried out in which the pressure is increased further, for example to 450 N/cm², but the temperature is reduced to room temperature.

Finally, the polymer laminate 100 produced in this manner is removed from the laminating press. This polymer laminate is shown in FIG. 3E. In order to produce an ID card 200, the card is cut out of the laminate in a precisely contoured manner, for example by means of a punching, milling or cutting process. Optionally, further security features are added.

A second embodiment of the method according to the invention for producing a polymer laminate 100 is shown in FIG. 4.

This method differs from the method according to the first embodiment in that the volume hologram element material 110, for example, contains no scratch-resistant layer. Moreover, the protective film 140 is not peeled from the diffracting layer 122 prior to the lamination step (method step (d)) and therefore remains in the volume hologram element 160. Furthermore, the volume hologram element with the carrier film 150 facing upward is combined with the PC layer 170, i.e., in the stack of layers 190 formed, the PC layer lies against the protective film of the volume hologram element. Moreover, one of the pressing plates P has an embossed structure P_{S} (elevated structures in this case) that produces an embossed structure 155 (depressions in this case) in the material of the carrier film in the volume hologram element.

In a first method step, the volume hologram element material 110 and a PC layer 170 are provided (corresponding to method step (a) of the method according to the invention; FIG. 4A). The volume hologram element material is characterized by a protective film 140 of PET, a light-sensitive layer 120 of a photopolymer applied thereto and a carrier film 150 of PC applied thereto.

After this, the pattern of the volume hologram is created by exposure in the volume hologram element material 110, wherein radiation in the visible spectral region VIS is used (FIG. 4B1). A light-diffracting layer 122 is formed from the light-sensitive layer 120, and a volume hologram element 160 is formed from the volume hologram element material. The volume hologram 125 is produced in the light-diffracting layer. After this, the diffraction pattern produced is fixed in the photopolymer by means of UV radiation UV (FIG. 4B2), corresponding to method step (b) of the method according to the invention.

In parallel to this, a print image 180 with personalizing data is produced on the PC layer 170.

After this, the volume hologram element 160, the printed PC layer 170 and optionally further polymer layers (the latter not shown) are combined to form a stack of layers 190 (corresponding to method step (c) of the method according to the invention; FIG. 4C), wherein the carrier film 150 of the volume hologram element is arranged facing upward and the protective film 140 is arranged facing downward towards the PC layer.

After this, the stack of layers 190 is fed into a laminating press, wherein it is arranged between two pressing plates P and this stack is placed between press rams S of the laminating press. In the laminating press, the stack is heated and placed under pressure, for example 110 N/cm², so that the layers of the stack of layers soften and bond to one another (FIG. 4D). This gives rise to the polymer laminate 100 (corresponding to method step (d) of the method according to the invention). The upper of the two pressing plates has a raised structure P_{S} that is embossed during lamination into the upper outer layer (carrier film 150) of the volume hologram element 160 in the form of depressions 155. In this manner, microoptical elements such as an array of microprisms are produced.

Finally, the finished polymer laminate 100 is ejected from the laminating press. The polymer laminate can be further processed into an ID card 200 or another value or security product.

Moreover, reference is made to the description of FIG. 3 with respect to the details of the individual method steps.

### REFERENCE SYMBOLS

100 Polymer laminate
110 Diffraction element material, volume hologram element material
120 Light-sensitive layer
122 Light-diffracting layer
125 Light-diffracting pattern, volume hologram
130 Scratch-resistant layer
140 Protective film
150 Carrier film
155 Embossed structure in polymer laminate, microoptical elements
160 Diffraction element, volume hologram element
170 Polymer layer, PC layer
180 Print image
190 Stack of layers
200 ID card, value or security product, value or security document
201 Upper side
202 Underside
210 First field
220 Second field
230 Third field
240 Fourth field
P Pressing plate
P_{S} Embossed structure on pressing plate
S Press ram
UV Radiation in the UV spectral region
VIS Radiation in the visible spectral region

1-14. (canceled)

15. A method for producing a polymer laminate, the method comprising the following steps:
(a) providing a diffraction element material having a carrier film and a light-sensitive layer on said carrier film, and at least one polymer layer;
(b) producing at least one diffraction element by producing a light-diffracting pattern in the light-sensitive layer of the at least one diffraction element material to thereby create a light-diffracting layer from the light-sensitive layer;
(c) bringing together the at least one diffraction element and the at least one polymer layer to form a stack of layers; and
(d) surface bonding the at least one diffraction element and the at least one polymer layer by a lamination process, to thereby form the polymer laminate with the at least one diffraction element.

16. The method according to claim 15, wherein method step comprises bonding the at least one diffraction element and the at least one polymer layer to each other without using an additional adhesive material.

17. The method according to claim 15, wherein the diffraction element material additionally has a scratch-resistant layer arranged on a side of the light-sensitive layer opposite the carrier film.

18. The method according to claim 17, which comprises, in steps and, retaining the scratch-resistant layer on the light-diffracting layer as a component of the polymer laminate to be produced.

19. The method according to claim 15, wherein step comprises arranging the at least one diffraction element on an outer side of the stack of layers.

20. The method according to claim 19, wherein step comprises arranging the light-diffracting layer on a side of the carrier film of the at least one diffraction element in the stack of layers that is opposite the at least one polymer layer.

21. The method according to claim 19, wherein:
step comprises arranging the carrier film on a side of the light-diffracting layer of the at least one diffraction element in the stack of layers that is opposite the at least one polymer layer, and the method further comprises, subsequent to step:
embossing microoptical elements in a material of the carrier film.

22. The method according to claim 15, wherein the carrier film is formed with polycarbonate or is composed of polycarbonate.

23. The method according to claim 15, wherein the at least one polymer layer is formed with polycarbonate or is composed of polycarbonate.

24. The method according to claim 15, wherein the at least one polymer layer is one of a plurality of polymer layers and at least one of the polymer layers is formed with polycarbonate or is composed of polycarbonate.

25. The method according to claim 15, wherein the diffraction element material includes a protective film arranged on a side of the light-sensitive layer opposite the carrier film, and the method further comprises, subsequent to step:
(b1) peeling of the protective film from the light-sensitive layer.

26. The method according to claim 15, which comprises providing at least one of the polymer layers with data.

27. The method according to claim 26, which comprises applying the data to the at least one of the polymer layers simultaneously with a production of the at least one diffraction element from the diffraction element material.

28. The method according to claim 15, which comprises producing a value or security product.

29. A polymer laminate, comprising:
a plurality of polymer layers; and
at least one diffraction element bonded to the polymer layers without additional adhesive material.

30. A value or security product, comprising a polymer laminate produced by the method according to claim 15.
